(19) United States
(12) Patent Application Publication
(10) Pub. No.: US 2006/0189396 A1
(43) Pub. Date: Aug. 24, 2006

(54) Driveline assembly with integrated joint and method of making the same

(76) Inventors: Keith A. Kozlowski, Saginaw, MI (US); Sergio Molinar, Cd. Juarez (MX); Federico Villalobos, Cd. Juarez (MX); Oscar H. Saldierna-Lopez, Cd. Juarez (MX)

Correspondence Address: DELPHI TECHNOLOGIES, INC., M/C 480-410-202, PO BOX 5052, TROY, MI, 48007, US

(21) Appl. No.: 11/358,182

(22) Filed: Feb. 21, 2006

Related U.S. Application Data
(60) Provisional application No. 60/655,769, filed on Feb. 24, 2005.

(51) Int. Cl. F16D 3/16

(52) U.S. Cl. 464/146

(57) ABSTRACT

The present invention provides a driveline assembly for transferring power from a vehicle transmission to a driveline component, such as a transfer case or differential. The driveline assembly comprises a drive shaft having a first end configured for operatively coupling to the vehicle transmission. A constant velocity (CV) joint assembly is mounted to a second, opposite end of the drive shaft. More specifically, the joint assembly includes an outer race welded to a tubular member of the drive shaft and an inner race disposed within the outer race. A plurality of torque-transmitting balls are disposed between the inner and outer races to transmit torque from the outer race to the inner race and on to the driveline component. The inner race is configured for mating with a secondary shaft coupled to the driveline component.

### CROSS REFERENCE TO RELATED APPLICATION

This application claims priority to and the benefit of U.S. provisional patent application Ser. No. 60/655,769, filed Feb. 24, 2005, hereby incorporated by reference.

### BACKGROUND OF THE INVENTION

1. Field of the Invention

The present invention relates generally to a driveline assembly for transmitting power from a vehicle transmission to a driveline component such as a transfer case or differential. More specifically, the present invention relates to the driveline assembly comprising a drive shaft and at least one joint assembly.

2. Description of Related Art

Driveline assemblies are well known for transferring power from a vehicle transmission to a driveline component such as a transfer case or differential. A typical driveline assembly comprises a drive shaft having a first end for operatively coupling to the vehicle transmission and a second end for operatively coupling to the transfer case or differential, usually through a joint assembly. Often, a constant velocity joint assembly is used for this purpose. The joint assembly comprises an inner race and an outer race disposed about the inner race. A plurality of torque-transmitting balls are disposed between the inner race and the outer race to transfer torque from the inner race to the outer race.

To construct a typical driveline assembly, the inner race is joined to the drive shaft through an intermediate stub shaft. More specifically, the inner race defines a bore having a first set of splines and the stub shaft has a splined end with a second set of splines mating with the first set of splines in the inner race. A second end of the stub shaft can be welded to a tubular member of the drive shaft. In this configuration, the outer race is mounted to a secondary shaft that is connected to the transfer case or differential or that forms part of the transfer case or differential.

By utilizing this configuration, the stub shaft is needed to complete the driveline assembly. However, with rising costs of parts and labor, there is a need in the art to improve the construction of driveline assemblies to reduce parts and associated labor. As a result, one potential improvement is to redue the use of stub shafts in driveline assemblies.

### SUMMARY OF THE INVENTION AND ADVANTAGES

The present invention provides a driveline assembly for transferring power from a vehicle transmission to a driveline component such as a transfer case or differential. The driveline assembly comprises a drive shaft having a first end configured for operatively coupling to the vehicle transmission. The drive shaft extends to a second end away from the vehicle transmission. A joint assembly is mounted to the second end of the drive shaft. More specifically, the joint assembly includes an outer race fixed to the second end of the drive shaft and an inner race disposed within the outer race for operatively coupling to the driveline component. The joint assembly also includes at least one torque-transmitting element disposed between the inner and outer races for transmitting torque from the outer race to the inner race and on to the driveline component. A method of constructing the driveline assembly is also provided.

The driveline assembly of the present invention eliminates the need for an intermediate stub shaft to connect the drive shaft to the joint assembly. Instead, the drive shaft is directly fixed to the outer race and the inner race is configured for operatively coupling to the driveline component. This provides a driveline assembly with an integrated joint. As a result, costs associated with parts and labor for constructing the driveline assembly can be reduced when compared to traditional driveline assemblies that utilize a stub shaft to fit the drive shaft to the joint assembly.

### BRIEF DESCRIPTION OF THE DRAWINGS

Other advantages of the present invention will be readily appreciated, as the same becomes better understood by reference to the following detailed description when considered in connection with the accompanying drawings wherein:

FIG. 1 is a partial cross-sectional view of a driveline assembly of the present invention including a joint assembly;

FIG. 2 is a cross-sectional view of the joint assembly of FIG. 1 taken generally along the line 2-2 in FIG. 1;

FIG. 3 is a partial top perspective view of an inner race of the joint assembly;

FIG. 4 is an illustration of a major diameter fit between a first set of splines of the inner race and a second set of splines of a secondary shaft;

FIG. 5 is an illustration of side fit splines;

FIG. 6 is a partial cross-sectional perspective view of the joint assembly connected to a drive shaft with a shipping plug inserted through a boot seal and partially inserted in the inner race;

FIG. 7 is a cross-sectional view of the boot seal with the secondary shaft illustrated in phantom;

FIG. 8 is a cross-sectional view of the boot seal with an insert molded clamp; and

FIG. 9 is a cross-sectional view of the boot seal with a second convoluted boot seal disposed thereabout.

### DETAILED DESCRIPTION OF THE INVENTION

Referring to the Figures, wherein like numerals indicate like or corresponding parts throughout the several views, a driveline assembly for transferring power from a vehicle transmission 12 to a driveline component 14 such as a transfer case or a differential is shown generally at 10.

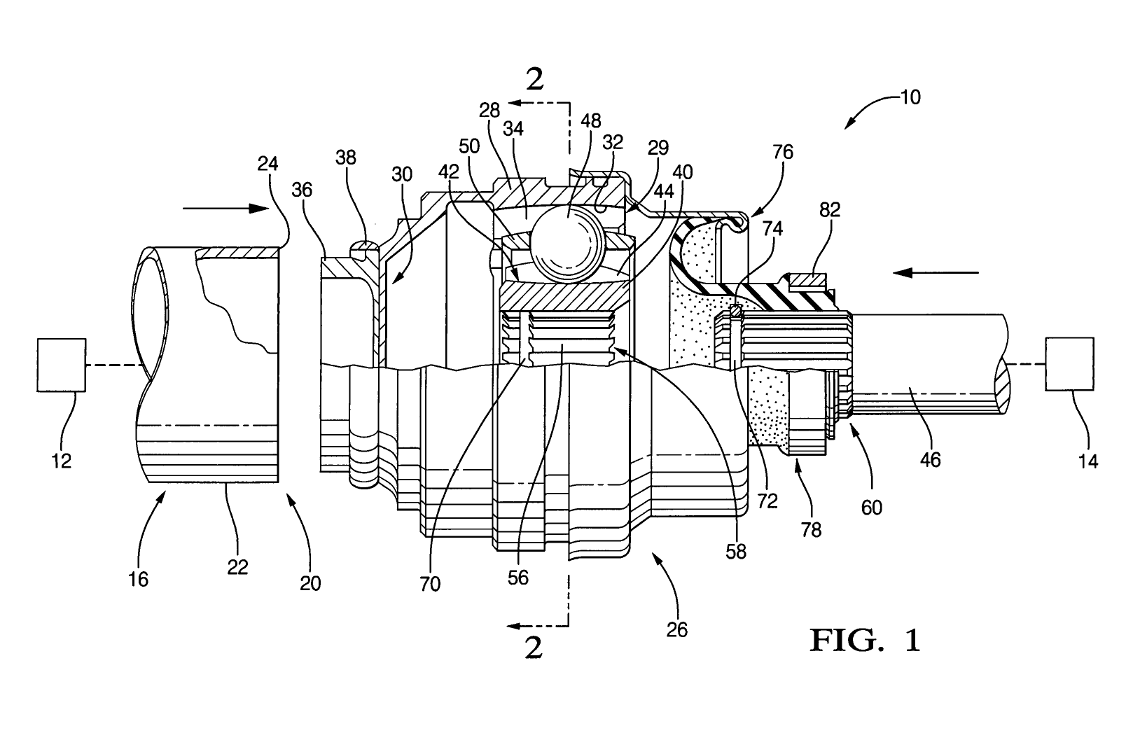

Referring to FIGS. 1-3, the driveline assembly 10 comprises a drive shaft 16 having a first end configured for operatively coupling to the vehicle transmission 12 (via an output shaft of the vehicle transmission) such as through a universal joint or other coupling mechanism (not shown). The drive shaft 16 extends from the vehicle transmission 12 to an opposite, second end 20. More specifically, the drive shaft 16 includes an elongated tubular member 22, preferably hollow, that extends from the vehicle transmission 12 to a cylindrically-shaped open end 24. A joint assembly 26, preferably in the form of a constant velocity joint assembly, is fixed to the open end 24 of the tubular member 22.

The joint assembly 26 includes a first joint member, known as an outer race 28, for mounting to the open end 24 of the tubular member 22. The outer race 28 has an open end 29, an opposite closed end 30, and an inner curved surface 32 in which a plurality of first ball grooves 34 are formed. The outer race 28 is fabricated separately from the drive shaft 16 on which the outer race 28 is to be mounted. The outer race 28 is formed with a weld flange 36 projecting from the closed end 30 having an outer cylindrical surface dimensioned to fit snuggly within the open end 24 of the tubular member 22. The outer cylindrical surface terminates at a shoulder 38 which abuts the open end 24 of the tubular member 22 when the weld flange 36 is extended fully into the open end 24. The connection between the outer race 28 and the tubular member 22 defines a joint which is secured permanently by welding at a joint line thereby providing the driveline assembly 10 with an integrated joint.

The joint assembly 26 also includes a second joint member, known as an inner race 40. The inner race 40 is disposed inside the outer race 28 and is formed with an outer curved surface 42 in which a plurality of second ball grooves 44 are formed. The inner race 40 is configured for operatively coupling with the driveline component 14. More specifically, the inner race 40 mates with a secondary shaft 46 mounted to the driveline component 14, or forming part of the driveline component 14, such as an output shaft of a transfer case, or an input shaft of a differential.

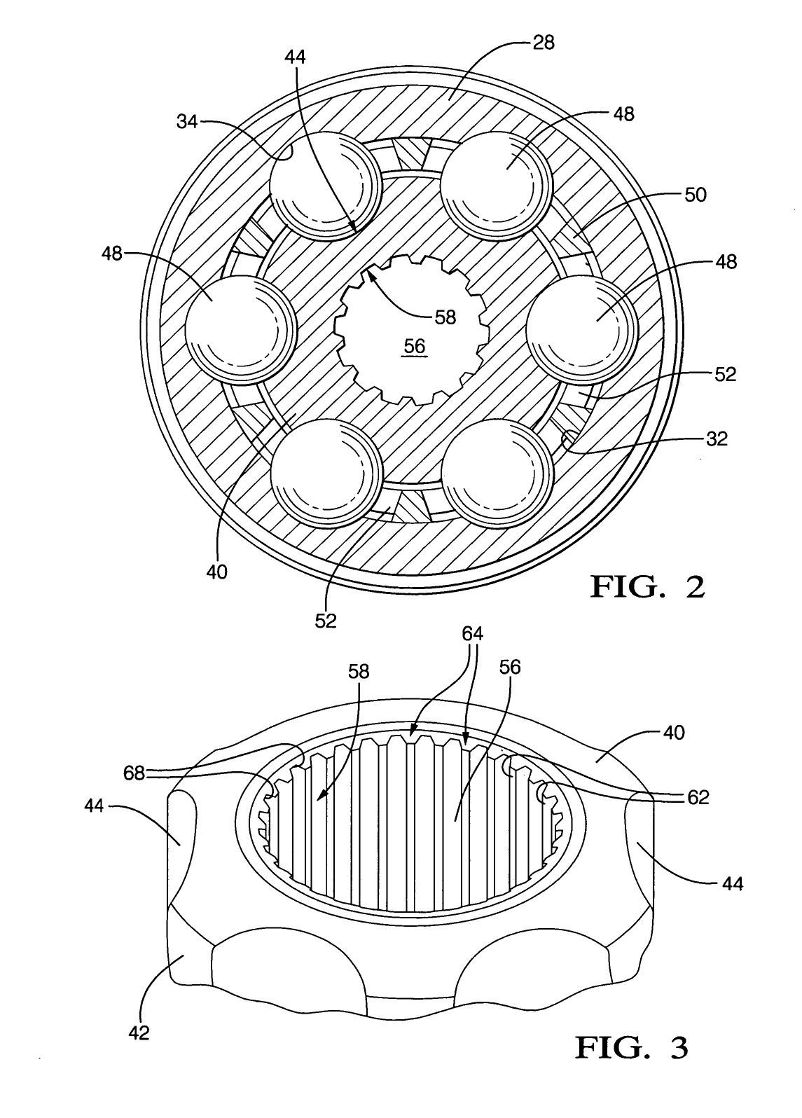

At least one torque-transmitting element 48 is disposed between the outer 28 and inner 40 races to operatively couple the outer 28 and inner 40 races together. The at least one torque-transmitting element 48 is further defined as a plurality of torque-transmitting balls 48 arranged in pairs of the first 34 and second 44 ball grooves between the outer 28 and inner 40 races. In other words, the plurality of first ball grooves 34 of the outer race 28 align with the plurality of second ball grooves 44 of the inner race 40 to define a plurality of guideways for accommodating the torque-transmitting balls 48. A cage 50 contains and secures the plurality of torque-transmitting balls 48 between the outer 28 and inner 40 races. The cage 50 is provided between the outer 28 and inner 40 races and is formed with a plurality of circumferentially spaced ball pockets 52 (see FIG. 2) or windows in which the plurality of torque-transmitting balls 48 are retained. The outer race 28 is able to move angularly relative to the inner race 40 and to transmit torque with constant velocity at an angle through interaction between joint surfaces and the torque-transmitting balls 48 in a known manner. The outer 28 and inner 40 races, the cage 50, and the torque-transmitting balls 48 may be formed of any material capable of transferring torque between the vehicle transmission 12 and the driveline component 14 including ferrous and non-ferrous metals, and the like.

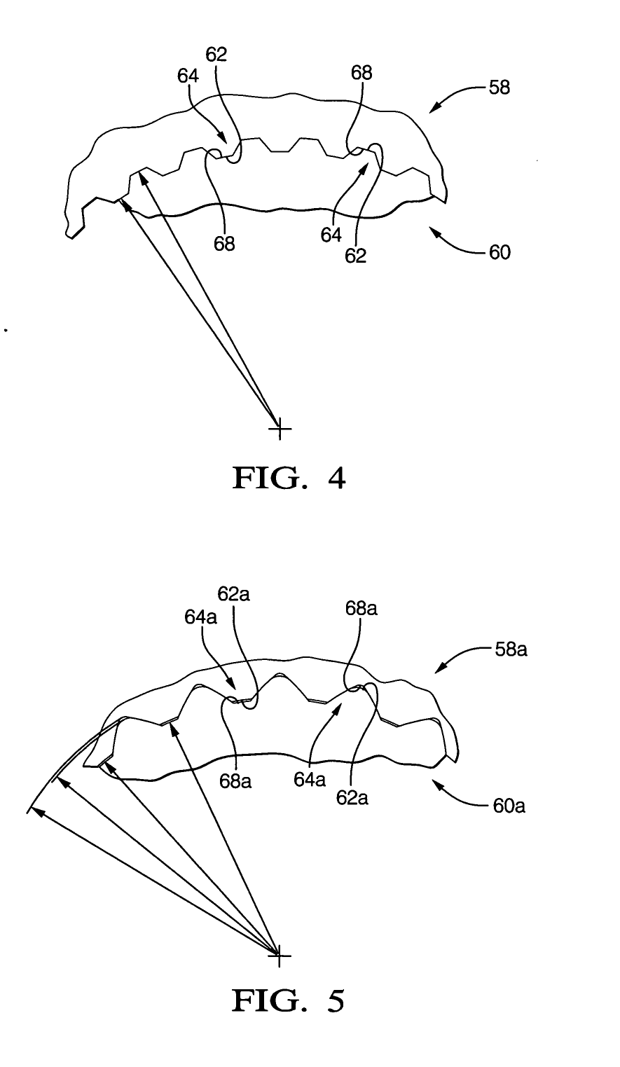

Referring to FIGS. 2-5, the inner race 40 includes a bore 56 with a first set of splines 58. The first set of splines 58 are designed for mating with a second set of splines 60 defined about the secondary shaft 46 (see FIG. 1). Referring specifically to FIG. 4, this splined connection is preferably a major diameter fit splined connection, where there is direct engagement of crowns 62 of spline teeth 64 of the first 58 and second 60 set of splines with roots of adjoining spline channels 68. FIG. 5 shows traditional sets of side-fit splines 58a, 60a that in alternative embodiments may be used to connect the inner race 40 and the secondary shaft 46. In the sets of side-fit splines 58a, 60a, shown in FIG. 5, it will be noted that the crowns 62a of the spline teeth 64a are spaced by a gap from the roots of adjoining spline channels 68a.

Referring back to FIG. 1, the bore 56 of the inner race 40 is formed with a first retaining groove 70 disposed circumferentially in the bore 56 and spaced inwardly from a longitudinal end of the inner race 40. The first retaining groove 70 penetrates at least partially through the spline teeth 64 of the first set of splines 58, and preferably entirely through each of the spline teeth 64 of the first set of splines 58, and in some embodiments is formed deeper than the spline channels 68. The secondary shaft 46 includes a similar second retaining groove 72 disposed circumferentially about the secondary shaft 46 and spaced inwardly from a longitudinal end of the secondary shaft 46. The second retaining groove 72 penetrates at least partially through the spline teeth 64 of the second set of splines 60, and preferably entirely through each of the spline teeth 64 of the second set of splines 60, and in some embodiments is formed deeper than the spline channels 68.

Still referring to FIG. 1, a retaining ring 74 is carried in the second retaining groove 72 on the secondary shaft 46. The first retaining groove 70 is thus blind and the retaining ring 74, once received in the first retaining groove 70, is buried and inaccessible from outside of the inner race 40. The retaining ring 74 is preferably received in the first retaining groove 70 by simply pressing the secondary shaft 46 into the bore 56, whereby the retaining ring 74 is caused to initially compress into the second retaining groove 72 by a chamfer for passage into and along the bore 56 until such time as the retaining ring 74 encounters the first retaining groove 70 at which point the retaining ring 74 returns outwardly into the first retaining groove 70 for retaining the secondary shaft 46 axially relative to the inner race 40. Thus, once the secondary shaft 46 is assembled to the inner race 40, the retaining ring 74 is seated in the first and second retaining grooves 70, 72 to axially restrain the secondary shaft 46 in the inner race 40.

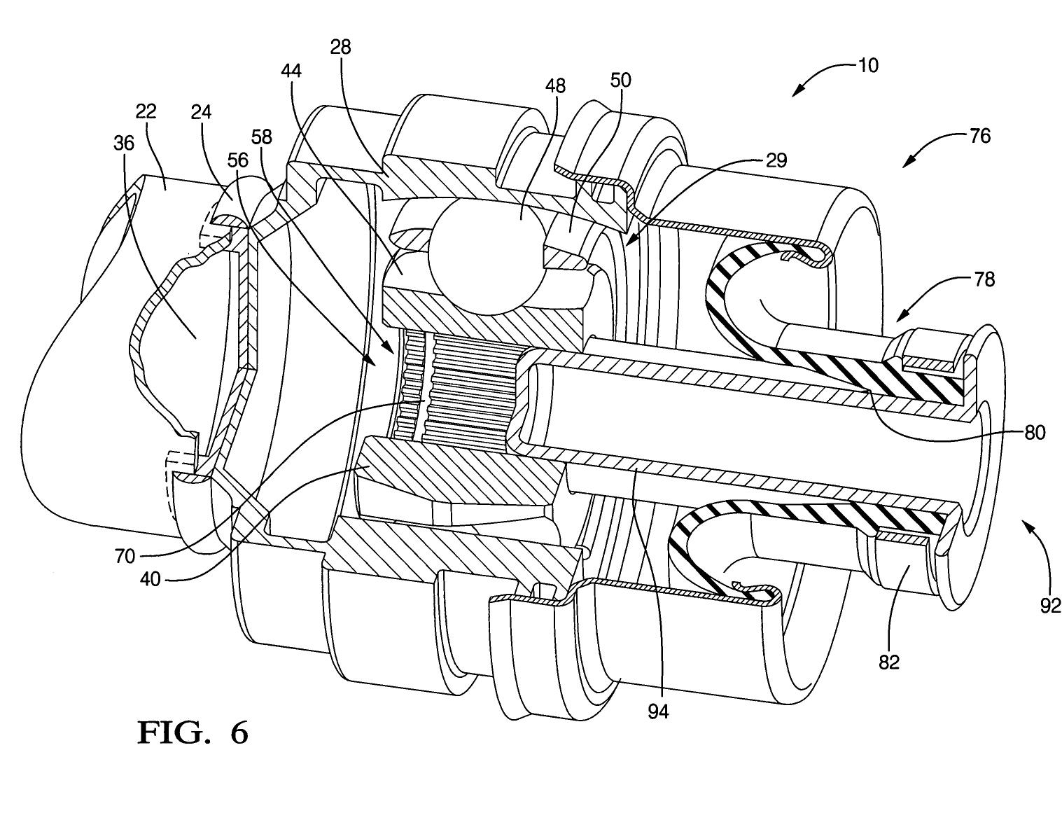

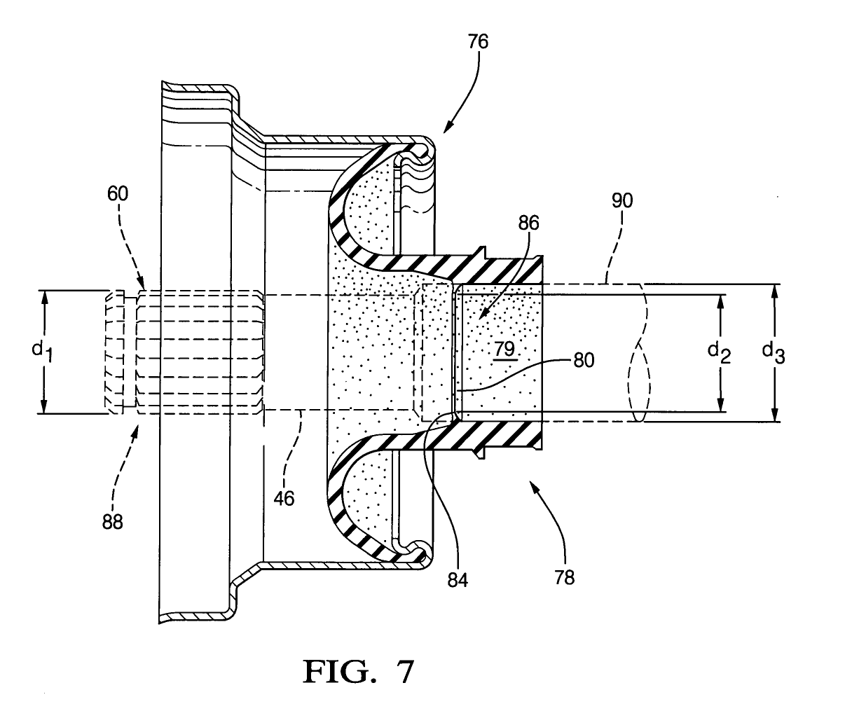

A boot seal 76 is fitted onto the open end 29 of the outer race 28 and is secured in sealed engagement about an outer perimeter portion of the outer race 28. The boot seal 76 is preferably a rolling-diaphragm boot seal 76 such as that disclosed in U.S. Pat. No. No. 6,406,034 B1 to Alcantara et al., hereby incorporated by reference, and illustrated in FIGS. 6-9. The boot seal 76 includes a central collar or neck portion 78 having a generally cylindrical configuration extending longitudinally outwardly of the outer race 28 for encircling and sealing about the secondary shaft 46 during use in order to retain a lubricant, such as grease, within the joint assembly 26 during use and to exclude contaminants such as dust, dirt, salt, water, etc. from entering the joint assembly 26 through the open end 29 of the outer race 28.

Referring to FIG. 7, the neck portion 78 has an inner surface 79 that is generally cylindrical. The neck portion 78 is formed with an inner annular wiper rib 80. In one embodiment, a clamp 82 (see FIG. 1) is disposed about the neck portion 78 for clamping the neck portion 78 to press the annular wiper rib 80 against the secondary shaft 46. The annular wiper rib 80 is preferably formed as an integral one piece feature of the boot seal 76, and comprises a circumferentially continuous, elastically deformable, sealing lip 84 projecting radially inwardly of the inner surface 79 of the neck portion 78 to present a constricted or reduced diameter region of the neck portion 78 that constricts about the secondary shaft 46 during use. In a free unstressed state, the lip 84 is preferably angled or inclined longitudinally inwardly away from an open end of the neck portion 78. The inward inclination reduces the insertion force of the secondary shaft 46. When the secondary shaft 46 is installed, the lip 84 deforms longitudinally inwardly of the open end of the neck portion 78 and radially inwardly relative to the initial free unstressed state of the lip 84 to a stressed position in which the lip 84 lies flush with the inner surface 79 of the neck portion 78. An outer region 86 of the neck portion 78 adjacent the axially outward side of the annular wiper rib 80 has an inner diameter which is relatively smaller than the inner diameter of the neck portion 78 on the opposite axially inner side of the annular wiper rib 80. The outer region 86 is disposed in running contact with the secondary shaft 46 during operation.

In FIG. 7, the secondary shaft 46 is shown in phantom. An end of the secondary shaft 46 having the second set of splines 60, hereinafter the splined end 88, preferably has a diameter d₁ that is relatively smaller than a diameter d₂ of the annular wiper rib 80 of the neck portion 78. A boot groove portion 90 of the secondary shaft 46 is provided adjacent the splined end 88 and is formed with a diameter d₃ greater than the diameter d₂ of the annular wiper rib 80. The smaller splined end 88 and larger boot groove portion 90 allow for easy installation of the secondary shaft 46 into the neck portion 78 of the boot seal 76 for connecting the secondary shaft 46 to the inner race 40 following the removal of a shipping plug 92 (see FIG. 6) while establishing a good seal about the boot groove portion 90 of the secondary shaft 46 following installation of the secondary shaft 46 into the inner race 40.

Referring to FIG. 6, the removable shipping plug 92 is shown. A shank 94 of the shipping plug 92 is disposed through the boot seal 76 prior to installation of the secondary shaft 46 into the inner race 40. According to one embodiment, the shipping plug 92 is dimensioned relative to the neck portion 78 such that a sufficient constricting retention force is exerted on the shipping plug 92 to support the shipping plug 92 against blowing out of the boot seal 76 as heat is introduced into the outer race 28 as a result of welding which would have the effect of increasing the pressure inside of the boot seal 76. In other words, welding the outer race 28 to the tubular member 22, i.e., the drive shaft 16, includes welding the outer race 28 to the drive shaft 16 at a welding temperature and controlling the welding temperature such that the removable shipping plug 92 remains secured in the neck portion 78 of the boot seal 76 during welding thereby preventing the shipping plug 92 from blowing out of the boot seal 76 to retain the lubrication disposed inside the joint assembly 26. Securing the removable shipping plug 92 in the neck portion 78 of the boot seal 76 with a retention force further includes clamping the neck portion 78 of the boot seal 76 about the removable shipping plug 92 with the clamp 82. The shipping plug 92 is removed from the boot seal 76 after operatively coupling the first end 18 of the drive shaft 16 to the vehicle transmission 12 and prior to mounting the secondary shaft 46 to the inner race 40.

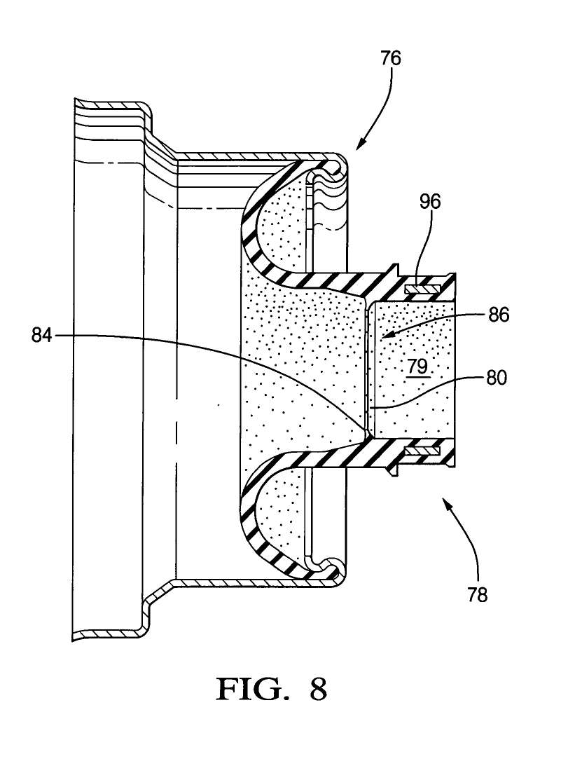

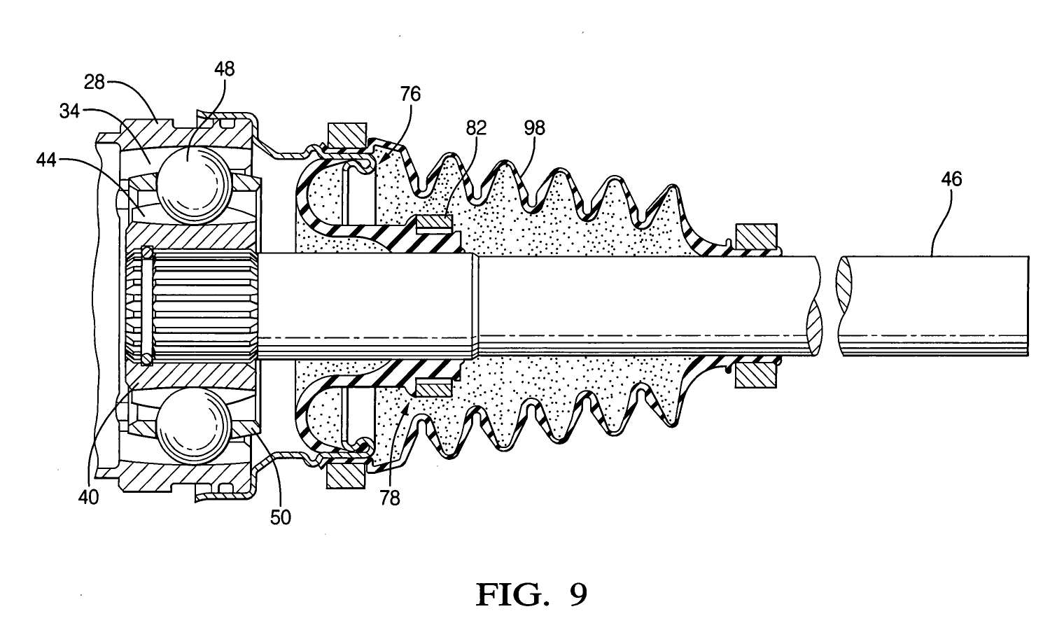

Referring to FIGS. 8 and 9, alternative embodiments of the boot seal 76 are shown. In FIG. 8, the boot seal 76 is modified to include a swage clamp 96 insert molded into the neck portion 78 of the boot seal 76. Another such variation is shown in FIG. 9, where the secondary shaft 46 does not include the boot groove portion 90, but a convoluted boot seal 98 overlies the boot seal 76 to retain the lubrication in the joint assembly 26.

The driveline assembly 10 of the present invention also presents a method of balancing the driveline assembly 10. Prior to installing or operatively coupling the drive shaft 16 (with welded joint assembly 26) to the vehicle transmission 12, the drive shaft 16 and joint assembly 24 can be balanced to ensure optimum performance of the driveline assembly 10. The balancing device used, such as a dynamic spin balancer (not shown), includes a plurality of balancing fixtures mounted to the driveline assembly 10 to test the balance of the driveline assembly 10. At least a portion of these balancing fixtures are attached to the inner race 40 to locate the center of rotation and the center of gravity of the drive shaft 16 and joint assembly 24.

Obviously, many modifications and variations of the present invention are possible in light of the above teachings. The invention may be practiced otherwise than as specifically described within the scope of the appended claims.

What is claimed is:

1. An assembly for transferring power from a vehicle transmission to a driveline component, comprising;
a drive shaft having a first end configured for operatively coupling to the vehicle transmission and extending to a second end, and
a joint assembly having an outer race fixed to said second end of said drive shaft and an inner race disposed within said outer race for operatively coupling to the driveline component,
said joint assembly including at least one torque-transmitting element disposed between said inner and outer races for transmitting torque from said outer race to said inner race and on to the driveline component.

2. An assembly as set forth in claim 1 including a secondary shaft for mounting to the driveline component.

3. An assembly as set forth in claim 2 wherein said inner race defines a bore having a first set of splines and said secondary shaft includes a second set of splines configured for mating with said first set of splines in a major diameter fit.

4. An assembly as set forth in claim 3 wherein said inner race defines a first retaining groove disposed circumferentially inside said bore and at least partially through said first set of splines and said secondary shaft defines a second retaining groove disposed circumferentially about said secondary shaft and at least partially through said second set of splines.

5. An assembly as set forth in claim 4 including a retaining ring for seating in said first and second retaining grooves to axially restrain said secondary shaft in said inner race.

6. An assembly as set forth in claim 2 including a boot seal secured to said outer race with said boot seal having a neck portion for encircling said secondary shaft and sealing to said secondary shaft.

7. An assembly as set forth in claim 6 including a clamp disposed about said neck portion for clamping said neck portion to said secondary shaft.

8. An assembly as set forth in claim 1 wherein said outer race includes a weld flange mounted to said second end of said drive shaft and said outer race is welded to said second end of said drive shaft.

9. A method of constructing a driveline assembly extending from a vehicle transmission wherein the driveline assembly comprises a drive shaft having first and second ends and a joint assembly including an outer race having a weld flange and an inner race disposed within the outer race with at least one torque-transmitting element disposed between the races, said method comprising the steps of;
mounting the weld flange of the outer race to the second end of the drive shaft,
welding the outer race to the second end of the drive shaft after mounting the weld flange to the second end of the drive shaft, and
operatively coupling the first end of the drive shaft to the vehicle transmission after welding the outer race to the second end of the drive shaft.

10. A method of constructing a driveline assembly as set forth in claim 9 including operatively coupling a secondary shaft to a driveline component.

11. A method of constructing a driveline assembly as set forth in claim 10 including mating the secondary shaft to the inner race of the joint assembly after operatively coupling the secondary shaft to the driveline component.

12. A method of constructing a driveline assembly as set forth in claim 11 wherein mating the secondary shaft to the inner race of the joint assembly includes aligning a first set of splines of the inner race with a second set of splines of the secondary shaft in a major diameter fit.

13. A method of constructing a driveline assembly as set forth in claim 11 including clamping a boot seal having a neck portion about the secondary shaft to retain lubrication in the joint assembly.

14. A method of constructing a driveline assembly as set forth in claim 11 including restraining axial movement of the secondary shaft in the inner race.

15. A method of constructing a driveline assembly as set forth in claim 9 including balancing the drive shaft and joint assembly prior to operatively coupling the first end of the drive shaft to the vehicle transmission.

16. A method of constructing a driveline assembly as set forth in claim 15 wherein balancing the drive shaft and joint assembly includes attaching at least one balancing fixture to the inner race.

17. A method of constructing a driveline assembly as set forth in claim 9 including securing a removable shipping plug in a neck portion of a boot seal mounted to the outer race with a retention force that holds the shipping plug in the neck portion such that lubrication inside the joint assembly remains disposed therein.

18. A method of constructing a driveline assembly as set forth in claim 17 wherein welding the outer race to the drive shaft includes welding the outer race to the drive shaft at a welding temperature and controlling the welding temperature such that the removable shipping plug remains secured in the neck portion of the boot seal during welding thereby preventing the shipping plug from blowing out of the boot seal to retain the lubrication disposed inside the joint assembly.

19. A method as set forth in claim 17 wherein securing the removable shipping plug in the neck portion of the boot seal with the retention force further includes clamping the neck portion of the boot seal about the removable shipping plug.

20. A method as set forth in claim 17 including removing the shipping plug from the boot seal after operatively coupling the first end of the drive shaft to the vehicle transmission.
